(19) United States
(12) Patent Application Publication
(10) Pub. No.: US 2014/0331580 A1
(43) Pub. Date: Nov. 13, 2014

(54) POST-TENSIONING CONCRETE PIPE WRAP

(71) Applicant: Hawkeye Concrete Products Co., Mediapolis, IA (US)

(72) Inventor: Claudio SUBACCHI, Mediapolis, IA (US)

(73) Assignee: Hawkeye Concrete Products Co., Mediapolis, IA (US)

(21) Appl. No.: 14/270,788

(22) Filed: May 6, 2014

Related U.S. Application Data
(60) Provisional application No. 61/822,548, filed on May 13, 2013.

(51) Int. Cl. E04C 5/08; B32B 37/00

(52) U.S. Cl. CPC E04C 5/08; B32B 37/00
USPC 52/223.14; 156/162

(57) ABSTRACT

A post-tensioning wrap includes a housing having at least one cavity and at least one tendon bonded to the housing. The wrap can be wrapped around the concrete article to equalize compression. Thereafter, a medium is injected into the cavity causing the housing to swell and compression of the concrete article by the tendon.

This application claims priority to U.S. Provisional Patent Application 61/822,548 filed May 13, 2013, the contents of which are hereby incorporated by reference herein.

Prestressed concrete plays a significant role in many of the building structures in use today. Prominent applications of prestressed concrete include: bridges, building columns, pressure cylinders, liquid storage tanks, and cylinders. Common to each of these applications, is the goal of eliminating tension forces in concrete load-bearing members, since concrete is notably weak in tension, but is strong in compression. In each of these applications, a prestressing force, applied prior to the concrete being loaded through use, is generated by stretching steel reinforcing members or tendons positioned internal to the concrete member. The stretched reinforcing members exert a compressive force on the concrete, which is arranged (in any one of several different ways) to prevent their relaxing.

Prestressing is commonly accomplished in one of two ways: pretensioning or post-tensioning, and may be applied either to pre-cast members manufactured off site, or may be done in the field, at the point of use of the concrete member. In pretensioning, stretched tendons are mechanically bonded to the concrete while the concrete is being cured. In the post-tensioning method, however, reinforcing members are prevented from being bonded to the concrete, thereby allowing the members to be stretched after the concrete is cured. Axially extending tendons are typically encased in sheaths to prevent bonding of the tendons to the concrete. When the concrete has been cured to a predetermined minimum strength, hydraulic jacks tension the tendons by working against the ends of the beam, thereby putting the beam in compression. An alternative technique, not requiring manual stretching of tendons, could provide significant economic and safety-related advantages.

### SUMMARY

A post-tensioning wrap for a concrete article includes a housing having at least one cavity and at least one tendon bonded to the housing. The wrap can be wrapped around the concrete article. Thereafter, a medium is injected into the cavity causing the housing to swell and compression of the concrete article by the tendon. In another embodiment, the housing has a plurality of cavities and a plurality of tendons each made from steel or a high tensile strength material with an elasticity modulus greater than or equal to the concrete in the concrete article.

More specifically, the tendon has a first end and a second end that corresponds with the housing that has a first end and a second end. The first end of the tendon extends beyond the first end of the housing and the second end of the tendon extends beyond the second end of the housing. A first clamp attached to the first end of the tendon and a second clamp attached to the second end of the tendon holds the tendon in place causing it to stretch and compress the concrete article.

In another embodiment, a method for making a pre-stressed concrete article is disclosed. A housing with at least one cavity and at least one tendon is wrapped around the concrete article. The tendons are clamped into place. The cavity is filled with a medium causing the housing to swell and compression of the concrete article by the tendon.

### BRIEF DESCRIPTION OF THE DRAWINGS

FIG. 1 is a front view of a post-tensioning wrap according to an embodiment of the invention.

FIG. 2 is a perspective view of the post-tensioning wrap of FIG. 1.

FIG. 3 is a side view of the post-tensioning wrap of FIG. 1.

FIG. 4 is a concrete culvert wrapped with the post-tensioning wrap of FIG. 1.

### DETAILED DESCRIPTION OF THE ILLUSTRATED EMBODIMENT

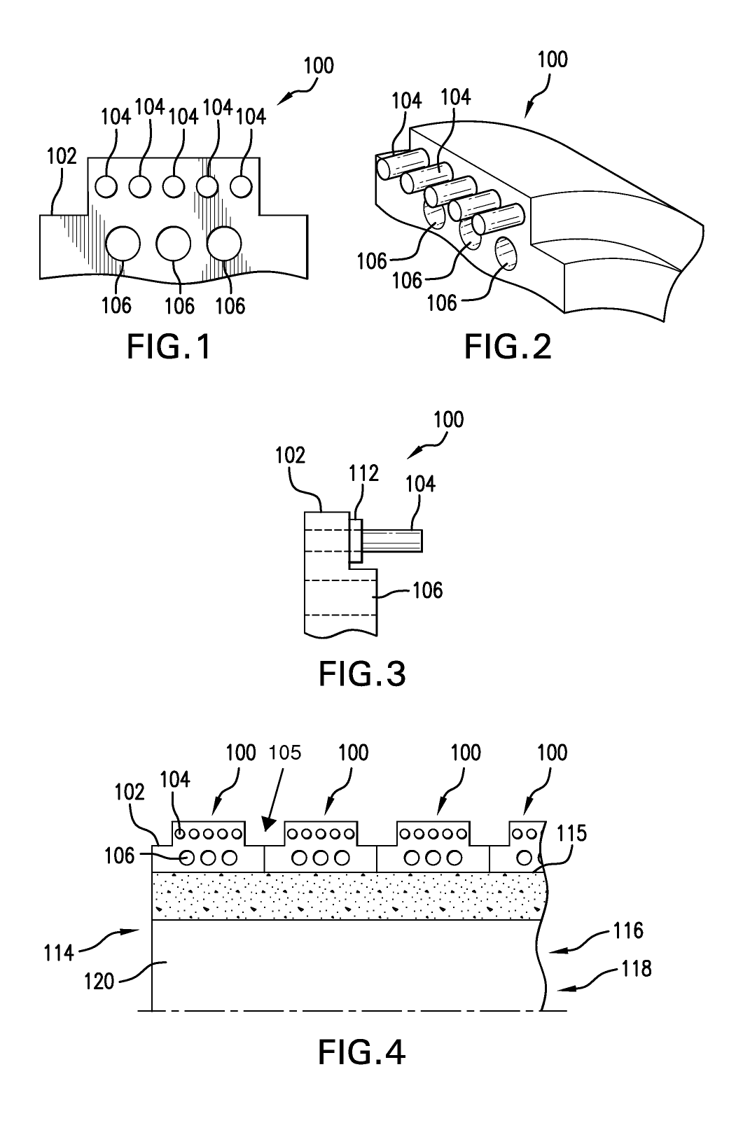

FIGS. 1-3 show a front, perspective, and side view of a post-tensioning wrap 100 according to an embodiment for making a pre-stressed concrete article. Post-tensioning wrap 100 includes a plastic housing 102 molded to at least one tendon 104. At least one cavity 106 is formed in housing 102 to receive a semi-viscous medium. The medium causes housing 102 to swell with the load being carried by tendons 104.

A concrete cylinder 108 is shown in FIG. 4. Cylinder 108 has a first end 114 and a second end 116 bounded by an external surface 115, and an inner bore 118 defined by an inner wall 120. Cylinder 108 can include interior steel members for reinforcement, but to save cost, the steel reinforcement members can be omitted. Cylinder 108 is fabricated using known techniques, and does not require any special processing, such as pressurizing or otherwise treating the concrete material as it hardens. The present disclosure is not limited to prestressing cylinder 108, but encompasses any concrete article that can benefit from prestressing, such as culverts of any shape or size, columns, enclosures, tanks, rigid members, etc.

Cylinder 108 is spirally wrapped either before or after curing with post-tensioning wrap 100. Wrap 100 is a single continuous wrap that is wrapped around cylinder 108. When done before curing, cylinder 108 can be cast inside a jacket that includes post-tensioning wrap 100, so that housing 102 is bonded to the outer-diameter of cylinder 108 as it cures; otherwise, post-tensioning wrap is wrapped around the outer surface of cylinder 108.

Once cylinder 108 is wrapped with post-tensioning wrap 100, each tendon 104 is anchored to housing 102 at each end of cylinder 108. The tendons can be made of high-strength steel which can satisfactorily maintain high working stresses, typically ranging between 150,000 and 180,000 pounds per square inch. The anchoring can be done in any manner known to those skilled in the art, such as with a clamp 112, as shown in FIG. 3, at each end of the tendon.

After tendons 104 are clamped to housing 102, the semi-viscous medium is injected into cavities 106 of post-tensioning wrap 100. Housing 102 swells from the medium, but the ends of tendons 104 are anchored to opposing ends of housing 102, which causes tendons 104 to stretch. The stretching of tendons 104 applies a compression force around cylinder 108.

Having described the general function of post-tensioning wrap 100, the specific elements are described in more detail.

Housing 102 is an injection molded plastic housing that is formed rigid enough to provide adequate retention of the pressurizing force without further, undesired swelling, which would detract from that force. Housing 102 can also be made from a low permeable material that shields tendons 104 from chemicals that might cause corrosion. In practice, the amount of swelling and the strength of housing 102 are well-defined using known principles to provide an accurate indication of the pressurization forces applied to cylinder 108.

Housing 102 is further injection molded around tendons 104 so that tendons 104 are bonded to housing 102. Tendons 104 can be made of any material suitable for withstanding the tensioning necessary to apply the necessary compression force to cylinder 108. Tendons 104 can be made from steel or any other fibrous or high tensile strength material with an elasticity modulus greater than or equal to the concrete; for example, tendons 104 could be made from fiber glass. The number of tendons 104 bonded to housing 102 is not intended to be limiting.

As previously stated, a semi-viscous medium is injected into cavities 106. Thereafter, the medium hardens or cures into a solid or other form which maintains the injection pressure with very little or no risk of leaking from the ends of cavity 106. More specifically, the medium can be a pressurized liquid or a high pressure medium comprising a grout of either plastic, epoxy resin or cementitious material, which is fluidically injected in cavity 106 and is thereafter allowed to cure or harden into a solid form. As used herein, the terms “cement” or “cementitious materials,” as applied to the pressurized medium refer to hydraulic cements and the like, which typically include calcium (e.g., calcium oxide and calcium sulfate), silicon (e.g., silicon oxide) and other similar elements, and are usable for making Portland Cement, concretes, mortars (including stuccos and plasters, such as Plaster of Paris), grouts, and other like materials. More specifically, these terms are not intended to include adhesives commonly referred to as “cements,” such as vinyl cement, plastic cement, rubber cement or the like which are used to bond vinyl, plastic, rubber and other components.

Pressure distributions according to the invention have improved uniformity, and pressure levels are easily controlled and measured, especially when swelling of the outer casing is monitored, as discussed above. It can be seen, therefore, that the prestressed concrete arrangement of the present invention provides uniform pressurizing of the outer surfaces of the prestressed concrete members. Further, the prestressing is accomplished with a single easily fabricated wrap. There is no need to apply a second coat of concrete to protect tendons 104 because tendons 104 are protected by housing 102. There is no need to post-tension tendons 104 with a separate machine, because the post-tensioning is applied by virtue of the expansion of housing 102 from the mortar. Finally, the post-tensioning method herein described is easier to carry out with less people resulting in significant time and cost savings.

Post-tensioning wrap 100 can be spirally wrapped around cylinder 114 with housing 102 positioned contiguously next to each other around cylinder 114, as shown in FIG. 4. A space 105 between each housing 102 can receive a weld to combine housing 102 to each other or some other low permeable barrier to the concrete to minimize chemical reactions with the soil that may have high or low pH or sulfates.

Reference has been made throughout this disclosure to “one embodiment,” “an embodiment,” or “embodiments” meaning that a particular described feature, structure, or characteristic is included in at least one embodiment of the present invention. Thus, usage of such phrases may refer to more than just one embodiment. Furthermore, the described features, structures, or characteristics may be combined in any suitable manner in one or more embodiments.

While the present invention has been particularly shown and described with reference to exemplary embodiments thereof, it should be understood by those of ordinary skill in the art that various changes, substitutions and alterations could be made herein without departing from the spirit and scope of the invention as embodied by the appended claims and their equivalents.

What is claimed is:

1. A post-tensioning wrap for a concrete article, comprising:
a housing having at least one cavity;
at least one tendon bonded to the housing; and
wherein the post-tensioning wrap is wrapped around the concrete article, and thereafter, a medium is injected into the cavity causing the housing to swell and compression of the concrete article by the tendon.

2. The post-tensioning wrap of claim 1, and further comprising a plurality of cavities.

3. The post-tensioning wrap of claim 1, and further comprising a plurality of tendons, wherein the plurality of tendons are positioned radially away from the concrete article and the cavities.

4. The post-tensioning wrap of claim 1, wherein the tendon is steel.

5. The post-tensioning wrap of claim 1, and wherein the tendon has a first end and a second end, and the housing has a first end and a second end, wherein the first end of the tendon extends beyond the first end of the housing and the second end of the tendon extends beyond the second end of the housing, and the post-tensioning wrap further comprises a first clamp attached to the first end of the tendon and a second clamp attached to the second end of the tendon to cause the tendon to stretch and compress the concrete article.

6. The post-tensioning wrap of claim 5, wherein the post-tensioning wrap is spirally wrapped around the concrete article to equalize compression around the concrete article.

7. A method of making a pre-stressed concrete article, the method comprising:
providing a housing with at least one cavity and a tendon extending through and out each end of the housing;
wrapping the housing around a concrete article;
clamping the tendon to the housing to prevent the tendon from slipping; and
filling the cavity with a medium.

8. The method of claim 7, wherein filling the cavity is fluidly injecting the cavity with the medium.

9. The method of claim 8, and further comprising expanding the housing with the medium causing the tendon to stretch thereby compressing the concrete article.

10. The method of claim 9, wherein the housing has a plurality of cavities.

11. The method of claim 10, wherein the housing has a plurality of tendons.

12. The method of claim 11, wrapping the housing around an external surface of the concrete article, and wherein the plurality of cavities are positioned radially between the concrete article and the plurality of tendons.

13. A post-tensioning wrap for a concrete article, comprising:
a housing having a fat least one cavity for receiving a medium for causing the housing to swell and compression of the concrete article;
at least one tendon bonded to the housing; and
wherein the post-tensioning wrap is spirally wrapped around the concrete article with a space between each contiguous position of the housing for a low permeable seal to combine each contiguous position of the housing.

14. The post-tensioning wrap of claim 13, and further comprising a plurality of cavities.

15. The post-tensioning wrap of claim 13, and further comprising a plurality of tendons, wherein the plurality of tendons are positioned radially away from the concrete article and the cavities.

16. The post-tensioning wrap of claim 13, wherein the tendon is one chosen from steel and a high tensile strength material with an elasticity greater than or equal to concrete.

17. The post-tensioning wrap of claim 13, and wherein the tendon has a first end and a second end, and the housing has a first end and a second end, wherein the first end of the tendon extends beyond the first end of the housing and the second end of the tendon extends beyond the second end of the housing, and the post-tensioning wrap further comprises a first clamp attached to the first end of the tendon and a second clamp attached to the second end of the tendon to cause the tendon to stretch and compress the concrete article.

18. The post-tensioning wrap of claim 17, wherein the post-tensioning wrap is spirally wrapped around the concrete article to equalize compression around the concrete article.

19. The post-tensioning wrap of claim 13, wherein the housing is made from a low permeable material to protect the tendon.
